(19) United States
(12) Patent Application Publication
(10) Pub. No.: US 2026/0225835 A1
(43) Pub. Date: Aug. 6, 2026

(54) MODULAR DOCK SEAL

(71) Applicant: Perma Tech Inc., Buffalo, NY (US)

(72) Inventors: Braden Stewart, Buffalo, NY (US); Richard Lund, Buffalo, NY (US)

(73) Assignee: Perma Tech Inc., Buffalo, NY (US)

(21) Appl. No.: 19/463,713

(22) Filed: Jan. 29, 2026

Related U.S. Application Data
(60) Provisional application No. 63/752,092, filed on Jan. 31, 2025.

(51) Int. Cl. B65G 69/00

(52) U.S. Cl. CPC B65G 69/008

(57) ABSTRACT

A modular dock seal for a loading dock to form an environmental enclosure along one or more side walls of a trailer when the trailer is parked in a trailer bay of the loading dock is provided. The loading dock has an exterior wall with a door opening. The modular dock seal includes a pair of side pad assemblies configured to be secured to the exterior wall of the loading dock alongside the door opening. Each side pad assembly comprises: (1) an upper compression pad comprising a top face and a bottom face; and (2) a lower compression pad comprising a top face and a bottom face, wherein the top face of the lower compression pad is arranged to meet the bottom face of the upper compression pad.

### CROSS-REFERENCE TO RELATED APPLICATIONS

This application claims priority to U.S. Provisional Patent Application Ser. No. 63/752,092, filed on Jan. 31, 2025, which application is hereby incorporated by reference in its entirety.

### FIELD OF THE DISCLOSURE

The present disclosure is generally directed to a modular dock seal for a loading dock that forms an environmental enclosure along side walls and a roof of a trailer parked in a loading dock trailer bay.

### BACKGROUND

Dock seals form an environmental enclosure between a trailer and a loading dock trailer bay of a receiving building, such as a warehouse. This enclosure is crucial to maintain environmental stability in a climate-controlled warehouse. Conventional dock seals include a pair of side pads configured to be installed vertically alongside an opening of the trailer bay. These side pads are typically long, unitary components. The length of these side pads make dock seal assemblies difficult and expensive to ship to end users. Further, the unitary nature of these side pads presents maintenance challenges to the dock seal, often requiring full replacement of these side pads due to natural wear from use in the trailer bay.

### SUMMARY OF THE DISCLOSURE

All examples and features described below can be combined in any technically possible way.

Generally, in one example, a modular dock seal for a loading dock to form an environmental enclosure along one or more side walls of a trailer when the trailer is parked in a trailer bay of the loading dock is provided. The loading dock has an exterior wall with a door opening.

The modular dock seal comprises a pair of side pad assemblies. The pair of side pad assemblies are configured to be secured to the exterior wall of the loading dock alongside the door opening.

Each side pad assembly includes (1) an upper compression pad comprising a top face and a bottom face and (2) a lower compression pad comprising a top face and a bottom face. The top face of the lower compression pad is arranged to meet the bottom face of the upper compression pad.

According to an example, the upper compression pad and the lower compression pad each have a length of less than or equal to 72 inches.

According to an example, the upper compression pad and the lower compression pad each have a weight of less than or equal to 60 pounds.

According to an example, the modular dock seal further includes a curtain assembly. The curtain assembly is configured to be secured to the exterior wall above the upper compression pad of each of the pair of side pad assemblies.

According to an example, the curtain assembly comprises a split backboard comprising a first board and a second board. The first board and the second board are both secured to the exterior wall.

The curtain assembly further includes a frame member secured to the split backboard.

The curtain assembly further includes a curtain affixed to and arranged to hang down from the frame member.

The curtain assembly further includes a split stiffener pipe attached to or arranged within the curtain. The split stiffener pipe comprises a first stiffener rod, a second stiffener rod, and a split rod coupling configured to connect the first stiffener rod to the second stiffener rod.

According to an example, the upper compression pad and/or the lower compression pad are substantially wedge-shaped.

According to an example, the upper compression pad and the lower compression pad each comprise (1) a foam body, (2) a base layer surrounding the foam body, and (3) a wear face partially covering the base layer.

Generally, according to another example, a method for assembling a modular dock seal is provided. The method includes: (1) coupling one or more brackets to each of a plurality of compression pads, wherein the plurality of compression pads comprises an upper left compression pad, a lower left compression pad, an upper right compression pad, and a lower right compression pad; (2) fastening, via a first portion of the one or more brackets, the upper left compression pad and the lower left compression pad along a left-side of a door opening in an exterior wall, wherein a top face of the lower left compression pad is arranged to meet a bottom face of the upper left compression pad; and (3) fastening, via a second portion of the one or more brackets, the upper right compression pad and the lower right compression pad along a right-side of the door opening in the exterior wall, wherein a top face of the lower right compression pad is arranged to meet a bottom face of the upper right compression pad.

According to an example, the one or more brackets are coupled to an outer face of each of the plurality of compression pads.

According to an example, the one or more brackets are angled brackets.

According to an example, the one or more brackets are coupled to a straight inner face of each of the plurality of compression pads.

According to an example, the one or more brackets are straight brackets.

According to an example, the method further comprises securing a curtain assembly to the exterior wall.

According to an example, securing the curtain assembly comprises: (1) securing a split backboard above the door opening in the exterior wall, wherein the split backboard includes a first backboard and a second backboard; (2) securing a frame member to the split backboard; (3) affixing a curtain to the frame member, wherein the curtain is arranged to hang down from the frame member; (4) connecting, via a split rod coupling, a first stiffener rod to a second stiffener rod to form a stiffener rod; and (5) arranging the stiffener rod within the curtain or attaching the stiffener rod to the curtain.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a front view of a modular dock seal, according to aspects of the present disclosure.

FIG. 2 shows isometric views of upper and lower compression pads of a modular dock seal, according to aspects of the present disclosure.

FIG. 3 is an exploded isometric view of a curtain assembly for a modular dock seal, according to aspects of the present disclosure.

FIG. 4 shows isometric views of portions of upper and lower compression pads of a modular dock seal, according to aspects of the present disclosure.

FIG. 5 is an isometric view of a disassembled and boxed modular dock seal, according to aspects of the present disclosure.

FIG. 6 is an isometric view of a modular dock seal installed around a door opening DO of an exterior wall EW of a loading dock, according to aspects of the present disclosure.

FIG. 7 is a flowchart of a method for assembling a modular dock seal, according to aspects of the present disclosure.

FIG. 8 is a flowchart of further steps of the method for assembling a modular dock seal, according to aspects of the present disclosure.

FIG. 9A illustrates a top view of a first arrangement of a pair of side pad assemblies installed on an external wall, according to aspects of the present disclosure.

FIG. 9B illustrates a top view of a second arrangement of a pair of side pad assemblies installed on an external wall, according to aspects of the present disclosure.

FIG. 9C illustrates a top view of a third arrangement of a pair of side pad assemblies installed on an external wall, according to aspects of the present disclosure.

FIG. 10A illustrates a front view of a pair of side assemblies, according to aspects of the present disclosure.

FIG. 10B illustrates an isometric view of a pair of side assemblies, according to aspects of the present disclosure.

### DETAILED DESCRIPTION OF EMBODIMENTS

The present disclosure relates to a modular dock seal. The modular dock seal forms an environmental enclosure around side walls of a trailer when the trailer is parked in a trailer bay of a loading dock. The loading dock is defined by an exterior wall with a door opening. The modular dock seal includes a pair of side assemblies and a curtain assembly. The side assemblies are configured to be secured to the exterior wall and are arranged vertically along the door opening. Each of the side assemblies includes an upper compression pad and a lower compression pad. Both of the upper compression pads are arranged on top of the lower compression pads, such that a bottom face of the upper compression pads meets a top face of the lower compressions pad to form a seam. The upper and lower compression pads may be substantially wedge-shaped, such that a front face of the pads is wider than a back face. Accordingly, the side assemblies form an environmental enclosure along the vertical sides of the door opening. Further, a curtain assembly is also configured to be secured to the exterior wall. The curtain assembly is arranged above the top faces of the upper compression pads to continue the aforementioned environmental enclosure along the top of the door opening. Dividing the side assemblies into two compression pads allows for the modular dock seal to be packaged in a more compact manner fitting standard dimensions for conventional freight, greatly reducing shipping costs. The smaller size of the compression pads, as opposed to a unitary side assembly, allows for easier installation, as each of the compression pads are light enough to be easily handled by an installer. These shipping and installation benefits are achieved while still providing sufficient protection to the door opening and the interior of the loading dock to external weather conditions.

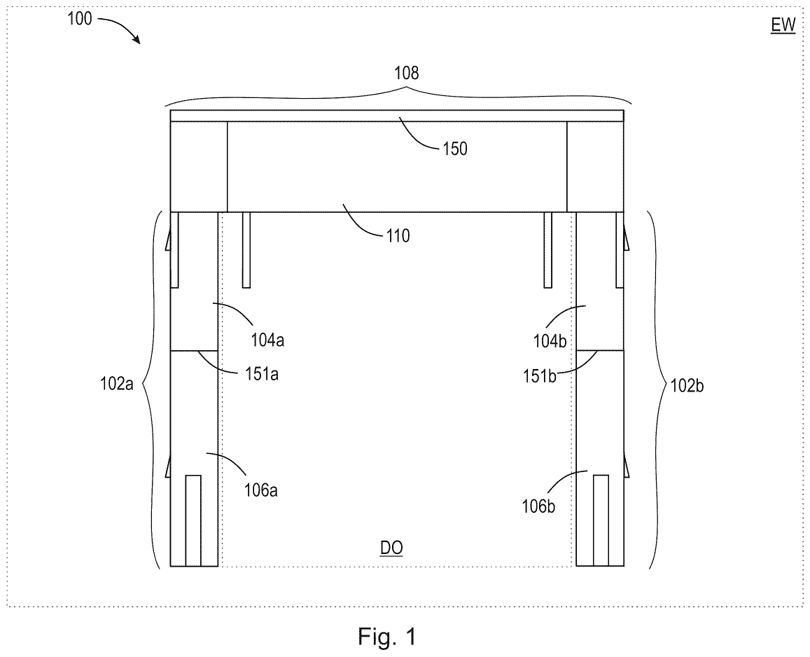

Turning to the figures, FIG. 1 is a front view of a non-limiting example of a modular dock seal 100. As can be seen in FIG. 1, the modular dock seal 100 is installed around a door opening DO and an exterior wall EW. This exterior wall EW is an aspect of a trailer bay of a loading dock. In some examples, the exterior wall EW may be brick, concrete, or metal. In the example of a concrete exterior wall EW, the exterior wall EW may be built from a plurality of concrete masonry units (CMUs). Accordingly, a vehicle (such as a semi-truck) hauling a trailer may back the trailer up to the door opening DO to unload goods from the trailer into the loading dock or load goods from the loading dock into the trailer. The modular dock seal 100 provides a weather sealing environmental enclosure between the door opening and the trailer to maintain a temperature-controlled environment within the loading dock and trailer during the loading or unloading process.

As shown in FIG. 1, the modular dock seal 100 includes a pair of side assemblies 102a, 102b and a curtain assembly 108. In particular, the pair of side assemblies 102a, 102b includes a left side assembly 102a and a right side assembly 102b. Each of the pair of side assemblies 102a, 102b is configured to be secured to the exterior wall EW around the door opening DO. The left side assembly 102a is arranged along the left side of the door opening DO and includes an upper left compression pad 104a and a lower left compression pad 106a. The upper left compression pad 104a meets the lower left compression pad 106a at a left seam 151a. The right side assembly 102b is arranged along the right side of the door opening DO and includes an upper right compression pad 104b and a lower right compression pad 106b. The upper right compression pad 104b meets the lower right compression pad 106b at a right seam 151b. In some examples, the left seam 151a may be covered by a flap attached to the upper left compression pad 104a, such that the flap slightly overlaps the lower left compression pad 106a. Similarly, the right seam 151b may also be covered by a flap attached to the upper right compression pad 104b, such that the flap slightly overlaps the lower right compression pad 106b. In some examples, the compression pads 104a, 104b, 106a, 106b may be referred to as “modular pads,” as the separable and replaceable nature of the compression pads 104a, 104b, 106a enables the modular benefits of the modular dock seal 100.

As will be described below, each of the compression pads 104a, 104b, 106a, 106b are configured to compress when the trailer is forced against the compression pads 104a, 104b, 106a, 106b, such as when the trailer is backed up to the door opening DO for loading and/or unloading. The compression pads 104a, 104b, 106a, 106b may be substantially wedge-shaped. In some examples, a distance between the innermost edges of the left side assembly 102a and the right assembly 102b may range from approximately 90 to 98 inches, such as from approximately 90 inches to 92 inches, from approximately 92 inches to 94 inches, from approximately 94 inches to 96 inches, from approximately 96 inches to 98 inches, and/or a range having any combination of endpoints thereof. In one particular example, the distance between the innermost edges of the left side assembly 102a and the right assembly 102b may be approximately 96 inches. Further, in some examples, each of the compression pads 104a, 104b, 106a, 106b may range from approximately 36 to 72 inches in height, such as from approximately 36 inches to 42 inches, from approximately 42 inches to 48 inches, from approximately 48 inches to 56 inches, from approximately 56 inches to 62 inches, from approximately 62 inches to 68 inches, from approximately 62 inches to 70 inches, from approximately 70 inches to 76 inches, and/or a range having any combination of endpoints thereof. In one particular example, each of the compression pads 104a, 104b, 106a, 106b may be approximately 60 inches in height.

The modular dock seal 100 also includes a curtain assembly 108. As shown in FIG. 1, the curtain assembly 108 includes a curtain 110 and a frame member 150. As will be described in more detail below, the curtain assembly 108 may be secured to the exterior wall EW such that the frame member 150 may be arranged above the upper compression pads 104a, 104b, enabling the curtain 110 to hang over upper portions of the upper compression pads 104a, 104b. In some examples, a width of the curtain 110 may range from approximately 108 to 138 inches, such as from approximately 108 inches to 114 inches, from approximately 114 inches to 120 inches, from approximately 120 inches to 126 inches, from approximately 132 inches to 138 inches, from approximately 138 inches to 142 inches, from approximately 142 inches to 148 inches, and/or a range having any combination of endpoints thereof. In one particular example, the width of the curtain 110 may be approximately 120 inches. As will be described in further detail below, the curtain assembly 108 may also include a split stiffener pipe 176 formed from a first stiffener rod 156a, a second stiffener rod 156b, and a split rod coupling 158 to couple to the first stiffener rod 156a to the second stiffener rod 156b.

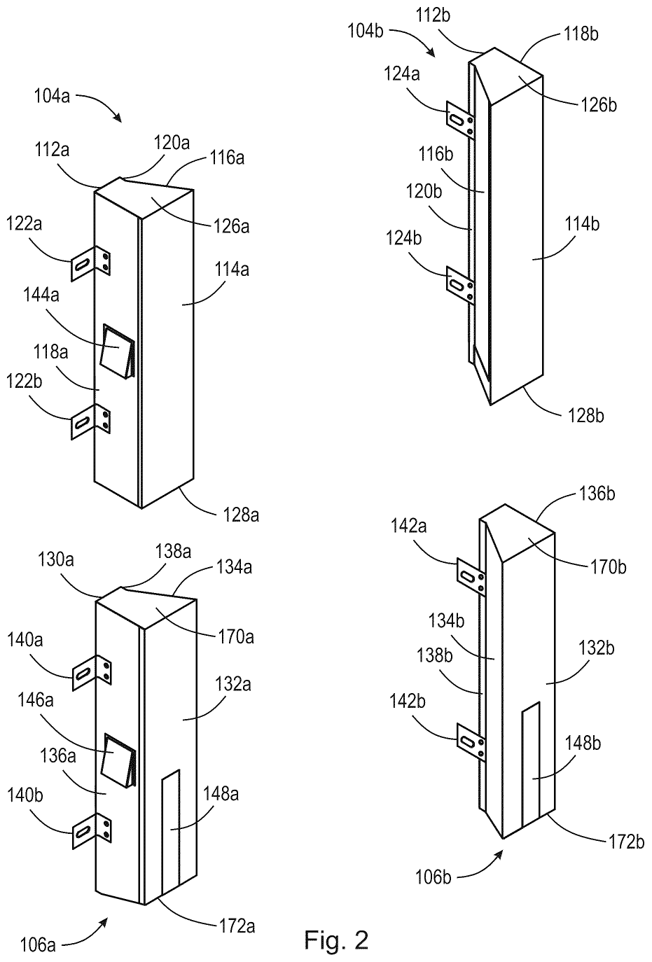

FIG. 2 shows isometric views of non-limiting examples of the compression pads 104a, 104b, 106a, 106b of the modular dock seal 100 shown in FIG. 1. In particular, FIG. 2 shows the upper left compression pad 104a defined by a back face 112a, a front face 114a, an angled inner face 116a, an outer face 118a, a straight inner face 120a, a top face 126a, and a bottom face 128a. The angle of the angled inner face 116a may range from approximately 14 degrees to 31 degrees, such as from approximately 14 degrees to 18 degrees, from approximately 18 degrees to 22 degrees, from approximately 22 degrees to 26 degrees, from approximately 26 degrees to 30 degrees, from approximately 30 degrees to 34 degrees, from approximately 34 degrees to 37 degrees, and/or a range having any combination of endpoints thereof. In one particular example, the angle of the inner face may be approximately 24 degrees. The wedge-shape of the upper left compression pad 104a is formed by the back face 112a, the front face 114a, the angled inner face 116a, the outer face 118a, and the straight inner face 120a. When the upper left compression pad 104a is mounted to the left of a door opening DO, the back face 112a meets the external wall EW, while the front face 114a faces outwards. Further, a first angled bracket 122a and a second angled bracket 122b are coupled to the outer face 118a to mount the upper left compression pad 104a to the exterior wall EW. The upper left compression pad 104a may further include a pair of straight brackets (not shown) coupled to the straight inner face 120a. The straight brackets described herein may also be referred to as “flat brackets.” The pair of straight brackets may be used to mount the upper left compression pad 104a to the frame of the door opening DO within the exterior wall EW. The upper left compression pad 104a may further include an air vent 144a arranged on the outer face 118a.

FIG. 2 further shows the lower left compression pad 106a defined by a back face 130a, a front face 132a, an angled inner face 134a, an outer face 136a, a straight inner face 138a, a top face 170a, and a bottom face 172a. The angle of the angled inner face 134a may range from approximately 14 degrees to 31 degrees, such as from approximately 14 degrees to 18 degrees, from approximately 18 degrees to 22 degrees, from approximately 22 degrees to 26 degrees, from approximately 26 degrees to 30 degrees, from approximately 30 degrees to 34 degrees, from approximately 34 degrees to 37 degrees, and/or a range having any combination of endpoints thereof. In one particular example, the angle of the inner face may be approximately 24 degrees. The wedge-shape of the lower left compression pad 106a is formed by the back face 130a, the front face 132a, the angled inner face 134a, the outer face 136a, and the straight inner face 138a. When the lower left compression pad 106a is mounted to the left of a door opening DO, the back face 130a meets the external wall EW, while the front face 132a faces outwards. Further, a first angled bracket 140a and a second angled bracket 140b are coupled to the outer face 136a to mount the lower left compression pad 106a to the exterior wall EW. The lower left compression pad 106a may further include a pair of straight brackets (not shown) coupled to the straight inner face 138a. The pair of straight brackets may be used to mount the lower left compression pad 106a to the frame of the door opening DO within the exterior wall EW. The lower left compression pad 106a may further include an air vent 146a arranged on the outer face 136a. As shown in FIG. 1, when the upper and lower left compression pads 104a, 106a are mounted around the door opening DO, the bottom face 128a of the upper left compression pad 104a meets the top face 170a of the lower left compression pad 106a to form the left seam 151a. Additionally, the lower left compression pad 106a may include a guide stripe 148a arranged on the front face 132a. The guide stripe 148a may be made of a bright and/or reflective material to assist drivers in properly docking a trailer within the modular dock seal 100.

FIG. 2 also shows the upper right compression pad 104b defined by a back face 112b, a front face 114b, an angled inner face 116b, an outer face 118b, a straight inner face 120b, a top face 126b, and a bottom face 128b. The angle of the angled inner face 116b may range from approximately 14 degrees to 31 degrees, such as from approximately 14 degrees to 18 degrees, from approximately 18 degrees to 22 degrees, from approximately 22 degrees to 26 degrees, from approximately 26 degrees to 30 degrees, from approximately 30 degrees to 34 degrees, from approximately 34 degrees to 37 degrees, and/or a range having any combination of endpoints thereof. In one particular example, the angle of the inner face may be approximately 24 degrees. The wedge-shape of the upper right compression pad 104b is formed by the back face 112b, the front face 114b, the angled inner face 116b, the outer face 118b, and the straight inner face 120b. When the upper right compression pad 104b is mounted to the right of a door opening DO, the back face 112b meets the external wall EW, while the front face 114b faces outwards. Further, a first straight bracket 124a and a second straight bracket 124b are coupled to the straight inner face 120 to mount the upper right compression pad 104b to the frame of the door opening DO within the exterior wall EW. The upper right compression pad 104b may further include a pair of angled brackets (not shown) coupled to the outer face 118b. The pair of angled brackets may be used to mount the upper right compression pad 104b to the exterior wall EW. The upper left compression pad 104a may further include an air vent (not shown) arranged on the outer face 118a.

FIG. 2 further shows the lower right compression pad 106b defined by a back face 130b, a front face 132b, an angled inner face 134b, an outer face 136b, a straight inner face 138b, a top face 170b, and a bottom face 172b. The angle of the angled inner face 134b may range from approximately 14 degrees to 31 degrees, such as from approximately 14 degrees to 18 degrees, from approximately 18 degrees to 22 degrees, from approximately 22 degrees to 26 degrees, from approximately 26 degrees to 30 degrees, from approximately 30 degrees to 34 degrees, from approximately 34 degrees to 37 degrees, and/or a range having any combination of endpoints thereof. In one particular example, the angle of the inner face may be approximately 24 degrees. The wedge-shape of the lower left compression pad 106b is formed by the back face 130b, the front face 132b, the angled inner face 134b, the outer face 136b, and the straight inner face 138b. When the lower right compression pad 106b is mounted to the right of a door opening DO, the back face 130b meets the external wall EW, while the front face 132b faces outwards. Further, a first straight bracket 142a and a second straight bracket 142b are coupled to the straight inner face 138b to mount the lower right compression pad 106b to the frame of the door opening DO within the exterior wall EW. The lower left compression pad 106b may further include a pair of angled brackets (not shown) coupled to the outer face 136b. The pair of angled brackets may be used to mount the lower right compression pad 106b to the frame of the door opening DO within the exterior wall EW. The lower left compression pad 106b may further include an air vent (not shown) arranged on the outer face 136b. As shown in FIG. 1, when the upper and lower right compression pads 104b, 106b are mounted around the door opening DO, the bottom face 128b of the upper right compression pad 104a meets the top face 170b of the lower right compression pad 106b to form the right seam 151b. Additionally, the lower right compression pad 106b may include a guide stripe 148b arranged on the front face 132b. The guide stripe 148b may be made of a bright and/or reflective material to assist drivers in properly docking a trailer within the modular dock seal 100.

In some examples, the compression pads 104a, 104b, 106a, 106b may include additional features. For example, rather than the air vents shown in FIG. 2, the compression pads 104a, 104b, 106a, 106b may include grommet holes to enable water to drain from the compression pads 104a, 104b, 106a, 106b.

The non-limiting example of FIG. 2 illustrates the compression pads 104, 104b, 106a, 106b implementing a first mounting style. In this mounting style, the outer faces 118a, 118b, 136a, 136b of each of the compression pads 104, 104b, 106a, 106b includes one or more angle brackets to be secured to the exterior wall EW via one or more bolts (for example, lag bolts), such as the angle brackets 122a, 122b of the upper left compression pad 104a and the angle brackets 140a, 140b of the lower left compression pad 106a. Further, the straight inner faces 120a, 120b, 138a, 138b of each of the compression pads 104, 104b, 106a, 106b includes one or more straight brackets to be secured to the frame of the door opening DO within the exterior wall EW via one or more bolts (for example, lag bolts), such as the straight brackets 124a, 124b of the upper right compression pad 104b and the straight brackets 142a, 142b of the lower right compression pads 106b. This first mounting style may be particularly useful when the door opening DO is greater than or equal to 108 inches wide. However, alternate mounting styles using different types and/or combination of brackets may be used. For example, if the door opening DO is less than 108 inches wide, a second mounting style may be implemented. In this second mounting style, the straight brackets of the first mounting style are replaced with angle brackets to be secured to the exterior wall EW rather than the frame within the door opening DO. This second mounting style is particularly applicable if the exterior EW is comprised of brick and/or concrete (such as a plurality of CMUs). Further, a third mounting style may be implemented if the door opening DO is less than 108 inches wide and the exterior wall EW is formed from metal. In this example, rather than attaching brackets to the compression pads 104a, 104b, 106a, 106b, the straight brackets may be used as washers inside of the exterior wall EW, and one or more bolts are driven through the straight brackets and the exterior wall EW directly into the back faces 112a, 112b, 130a, 130b of the compression pads 104a, 104b, 106a, 106b.

As can be understood by the description above, the compression pads 104a, 104b, 106a, 106b are significantly smaller than the compression pads used by conventional dock seal systems, as the conventional compression pads must be long enough to correspond to the full height of the door opening. The compression pads 104a, 104b, 106a, 106b of FIG. 2 are significantly shorter and lighter than conventional compression pads for easier maneuverability during installation.

Further, breaking up the side assemblies 102a, 102b into modular compression pads 104a, 104b, 106a, 106b allows for the individual modular compression pads 104a, 104b, 106a, 106b to be replaced when the side assemblies 102a, 102b experience damage or wear, rather than requiring an entire side assembly 102a, 102b to be replaced. For example, certain trailers may be more likely to damage the lower compression pads 106a, 106b than the upper compression pads 104a, 104b. Therefore, one or both of the lower compression pads 106a, 106b could be replaced several times while leaving the original upper compression pads 104a, 104b in place.

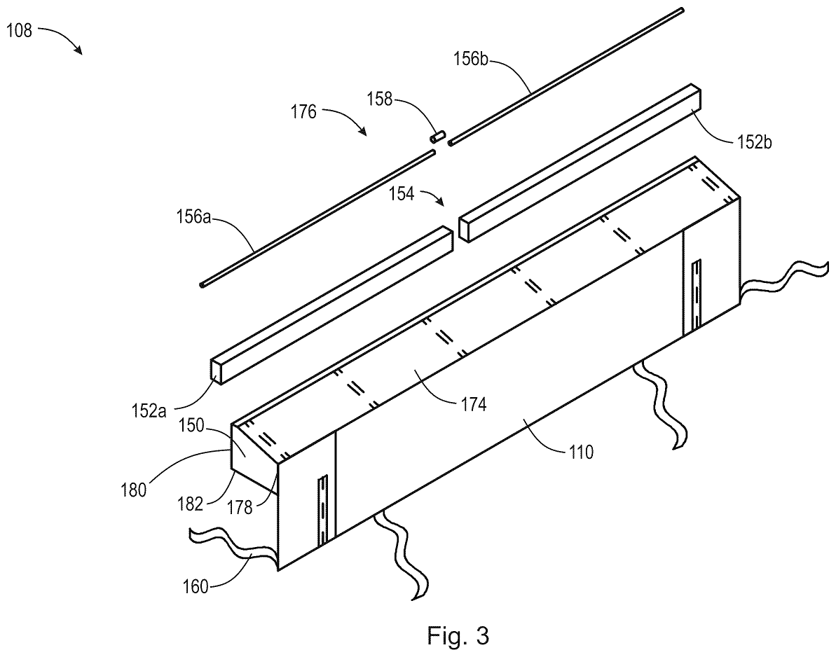

FIG. 3 shows an exploded isometric view of the curtain assembly 108 of FIG. 1. Broadly, the non-limiting example of the curtain assembly 108 includes a curtain 110, a frame member 150, a split backboard 154, and a split stiffener pipe 176. The curtain 110 is configured to be secured to a front face 178 of the frame member 150. In some examples, the curtain 110 may be comprised of vinyl or a similar material. One or more tie-back straps 160 may be fixed to the curtain 110 to enable the curtain 110 to be secured into a variety of positions.

As shown in FIG. 3, the frame member 150 may be substantially trapezoidal. Accordingly, the frame member 150 includes a sloped top face 174. This sloped top face 174 prevents water, snow, and other debris from collecting on top of the frame member 150. Upon installation, a bottom face 182 of the frame member 150 may contact the top face 126a of the upper left compression pad 104a and the top face 126b of the upper right compression pad 104b.

In the non-limiting example of FIG. 3, the split backboard 154 includes a first board 152a and a second board 152b. The split backboard 154 may be divided into two (or more) components for packaging and shipping purposes. The split backboard 154 may be mounted to the external wall EW, and the back face 180 of the frame member 150 may be coupled to the split back board 154, thereby securing the frame member 150 to the external wall EW.

Further to the non-limiting example of FIG. 3, the split stiffener pipe 176 may be formed from three discrete components: a first stiffener rod 156a, a second stiffener rod 156b, and a split rod coupling 158. The split stiffener pipe 176 may be shipped as these three discrete components. When assembled, the split stiffener pipe 176 may be attached to or arranged within the curtain 110 to “stiffen” the upper portion of the curtain 110.

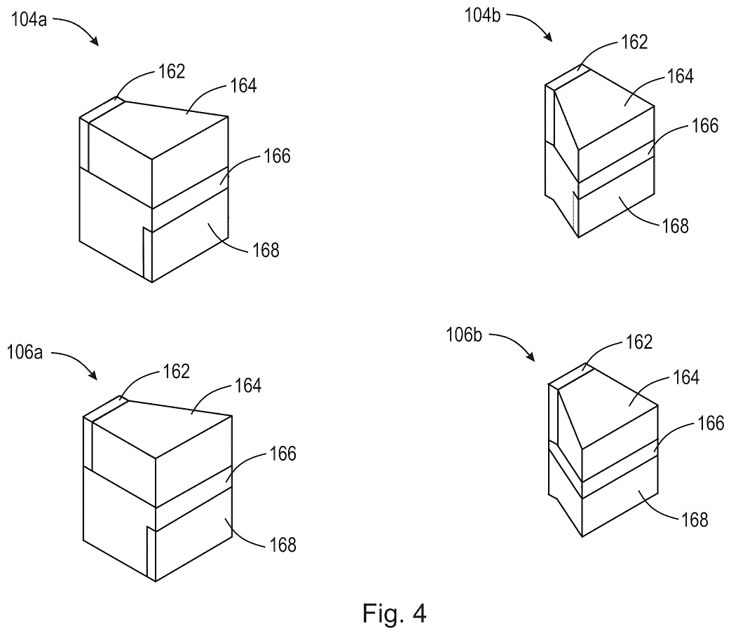

FIG. 4 shows isometric views of portions of compression pads 104a, 104b, 106a, 106b of a modular dock seal 100. These views depict the various materials used to manufacture the compression pads 104a, 104b, 106a, 106b. As shown in FIG. 4, each compression pad 104a, 104b, 106a, 106b includes a backboard 162 which may be comprised of wood, fabricated metal (such as rolled steel), or composite materials such as recycled plastic, polyvinyl chloride (PVC), etc. Further, each compression pad 104a, 104b, 106a, 106b includes a foam wedge 164. In some examples, this foam wedge 164 may be comprised of polyurethane foam. The foam wedge 164 enables the compression pads 104a, 104b, 106a, 106b to compress and decompress. Further, each compression pad 104a, 104b, 106a, 106b includes a base layer 166. The base layer 166 may be comprised of a polyester fabric. The base layer 166 surrounds and envelops the backboard 162 and the foam wedge 164 of each compression pad 104a, 104b, 106a, 106b. In some examples, the base layer 166 may have a tensile strength between approximately 301 and 900 pounds, such as from approximately 301 pounds to 500 pounds, from approximately 500 pounds to 700 pounds, from approximately 700 pounds to 900 pounds, and/or a range having any combination of endpoints thereof.

As shown in FIG. 4, each of the compression pads 104a, 104b, 106a, 106b further includes a wear face 168. The wear face 168 may be a permanently affixed layer comprised of a more durable material than the base layer 166. In some examples, the wear face 168 may have a length ranging from approximately 4 to 16 inches. Accordingly, the wear face 168 may be comprised of a polyester fabric having a tensile strength between approximately 453 and 900 pounds, such as from approximately 453 pounds to 600 pounds, from approximately 600 pounds to 750 pounds, from approximately 750 pounds to 900 pounds, and/or a range having any combination of endpoints thereof. The wear faces 168 of the upper compression pads 104a, 104b may fully cover the front faces 114a, 114b of the upper compression pads 104a, 104b, with some slight overlap onto the corresponding angled inner faces 116a, 116b and outer faces 118a, 118b. By contrast, the wear faces 168 of the lower compression pads 106a, 106b may fully cover the front faces 132a, 132b, the angled inner faces 134a, 134b, and the straight inner faces 138a, 138b, with some slight overlap onto the corresponding outer faces 136a, 136b. This additional protection on the inner faces 134a, 134b, 138a, 138b of the lower compression pads 106a, 106b may be necessary to guard against abrasion and other damage occurring when loading and unloading large pallets.

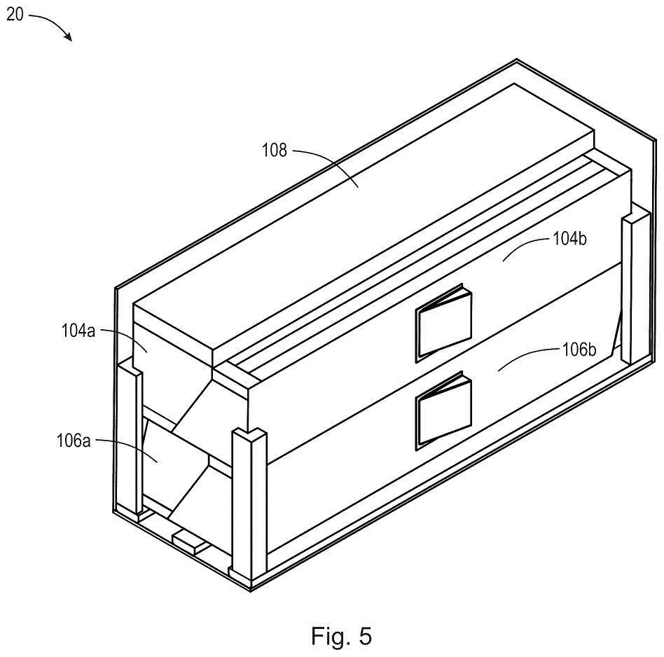

FIG. 5 is an isometric view of a disassembled modular dock seal 100 arranged in a shipping container 20. As shown, the lower compression pads 106a, 106b are positioned on the bottom of the shipping container such that their corresponding angled inner faces 134a, 134b meet. Similarly, the upper compression pads 104a, 104b are positioned on top of the lower compression pads 106a, 106b such that their corresponding angled inner faces 116a, 116b also meet. Aspects of the curtain assembly 108 are arranged on the front face 114a of the upper left compression pad 104a. Accordingly, the disassembled modular dock seal 100 may be packaged in a compact and efficient manner when compared to conventional dock seals. In particular, the shipping container 20 fits standard dimensions of conventional freight for more efficient transportation.

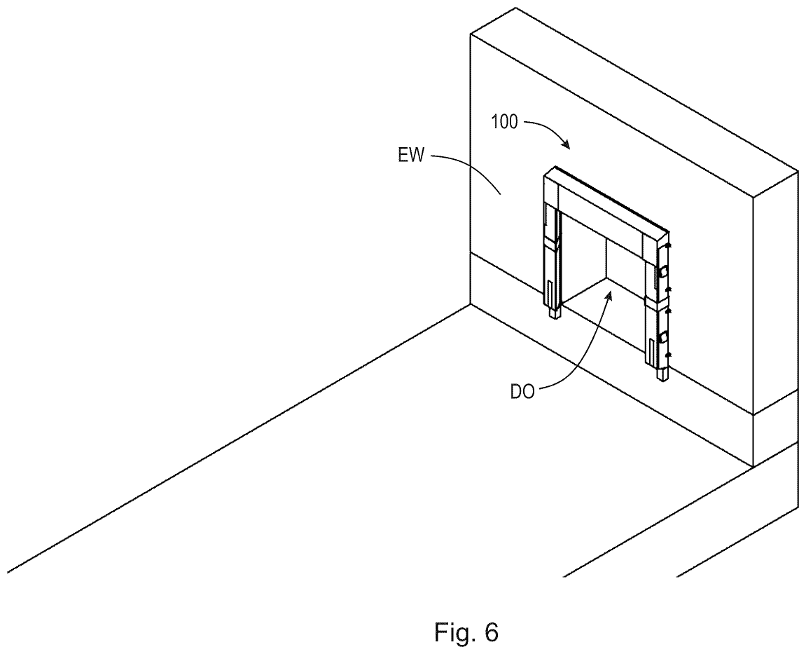

FIG. 6 is an isometric view of a modular dock seal 100. The modular dock seal 100 is installed around a door opening DO of an exterior wall EW of a loading dock of a trailer bay. Accordingly, a vehicle hauling a trailer may back the trailer up to the door opening DO to unload goods from the trailer into the loading dock or load goods from the loading dock into the trailer. The modular dock seal 100 will form an environmental enclosure around the trailer backed up to the door opening DO to maintain environmental stability in a climate-controlled warehouse.

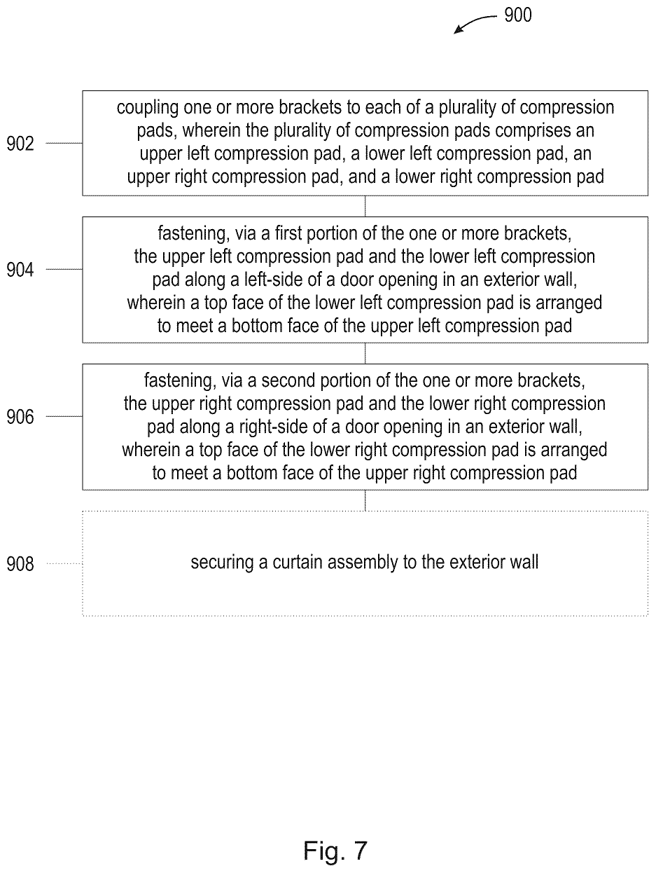

FIG. 7 is a flowchart of a method 900 for assembling a modular dock seal 100. With reference to FIGS. 1-10B, the method 900 includes, in step 902, coupling one or more brackets 122, 124, 140, 142 to each of a plurality of compression pads 104, 106, wherein the plurality of compression pads 104, 106 comprises an upper left compression pad 104a, a lower left compression pad 106a, an upper right compression pad 104b, and a lower right compression pad 106b.

The method 900 further includes, in step 904, fastening, via a first portion of the one or more brackets 122, 124, 140, 142, the upper left compression pad 104a and the lower left compression pad 106a along a left-side of a door opening DO in an exterior wall EW, wherein a top face 170a of the lower left compression pad 106a is arranged to meet a bottom face 128a of the upper left compression pad 104a.

The method 900 further includes, in step 906, fastening, via a second portion of the one or more brackets 122, 124, 140, 142, the upper right compression pad 104b and the lower right compression pad 106b along a right-side of the door opening DO in the exterior wall EW, wherein a top face 170b of the lower right compression pad 106b is arranged to meet a bottom face 128b of the upper right compression pad 104b.

In some examples, the method 900 may further include, in optional step 908, securing a curtain assembly 108 to the exterior wall EW.

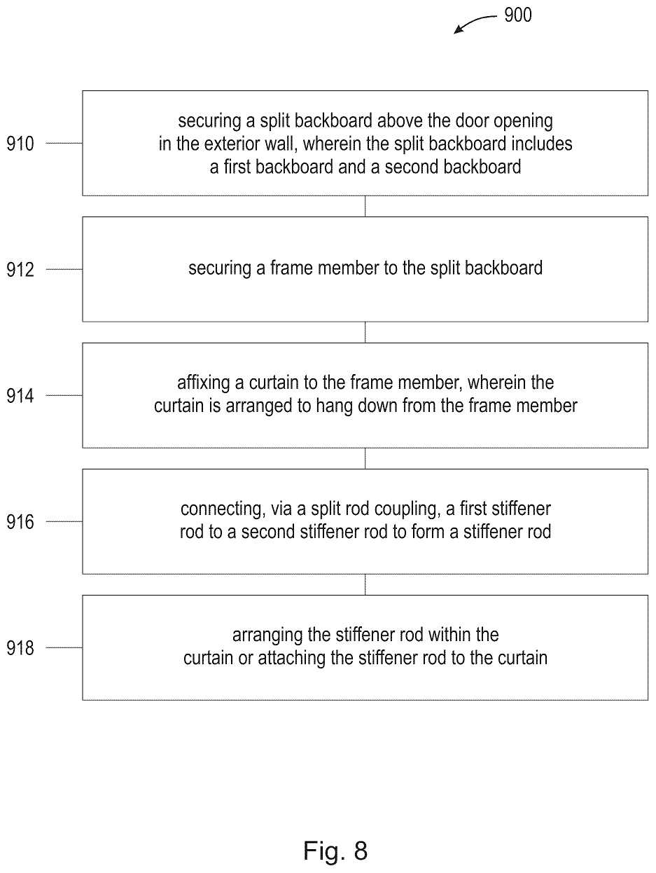

FIG. 8 is a flowchart of further steps of the method 900. In particular, the steps of FIG. 8 are directed to a subroutine for securing the curtain assembly 108 to the exterior wall EW. In particular, the subroutine for securing the curtain assembly 108 to the exterior wall EW include, in optional step 910, securing a split backboard 154 above the door opening DO in the exterior wall EW, wherein the split backboard 154 includes a first backboard 152a and a second backboard 152a.

The subroutine of FIG. 8 further includes, in optional step 912, securing a frame member 150 to the split backboard 154.

The subroutine of FIG. 8 further includes, in optional step 914, affixing a curtain 110 to the frame member 150, wherein the curtain 110 is arranged to hang down from the frame member 150.

The subroutine of FIG. 8 further includes, in optional step 916, connecting, via a split rod coupling 158, a first stiffener rod 156a to a second stiffener rod 156b to form a stiffener rod 176.

The subroutine of FIG. 8 further includes, in optional step 918, arranging the stiffener rod 176 within the curtain 110 or attaching the stiffener rod 176 to the curtain 110.

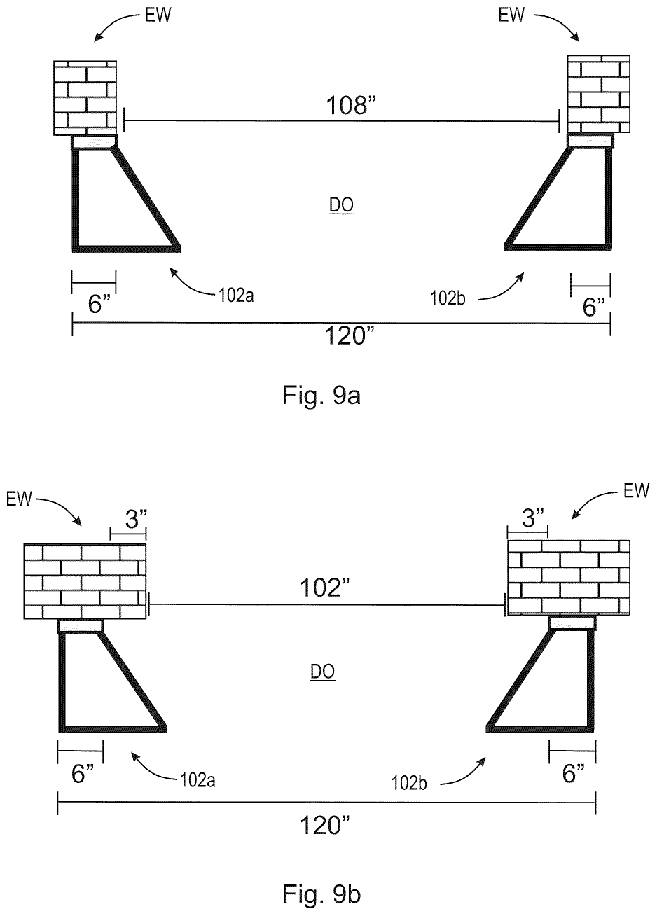

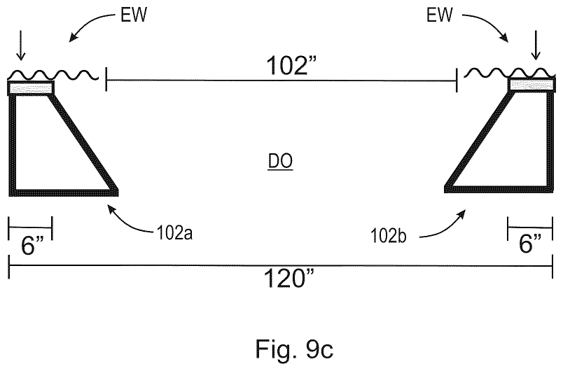

FIG. 9A-9C illustrate various examples of different configurations for installing the side assemblies 102a, 102b. In these examples, the modular dock seal 100 as a whole is considered to be approximately 120 inches wide as measured from the outer faces 118a, 136a of the left side assembly 102a to the outer faces 118b, 136a of the right side assembly 102b. In these examples, the various brackets 122, 124, 140, 142 are coupled to the side assemblies 102a, 102b using lag bolts. The side assemblies 102a, 102b are then fastened directly to the loading dock, whether to the external wall EW of the loading dock or the door opening DO within the external wall EW.

In the example of FIG. 9A, the external wall EW is made of brick and/or concrete, and the width of the door opening DO is approximately 108 inches. Accordingly, side assemblies 102a, 102b are arranged flush with the door opening and are mounted using a combination of angled brackets 122, 140 and straight brackets 124, 142.

In the example of FIG. 9B, the external wall EW is again made of brick and/or concrete, while the width of the door opening DO is approximately 102 inches. In order to provide sufficient clearance between the side assemblies 102a, 102b, the side assemblies 102a, 102b are mounted outside of the door opening DO using only angled brackets 122, 140 (rather than straight brackets 124, 142).

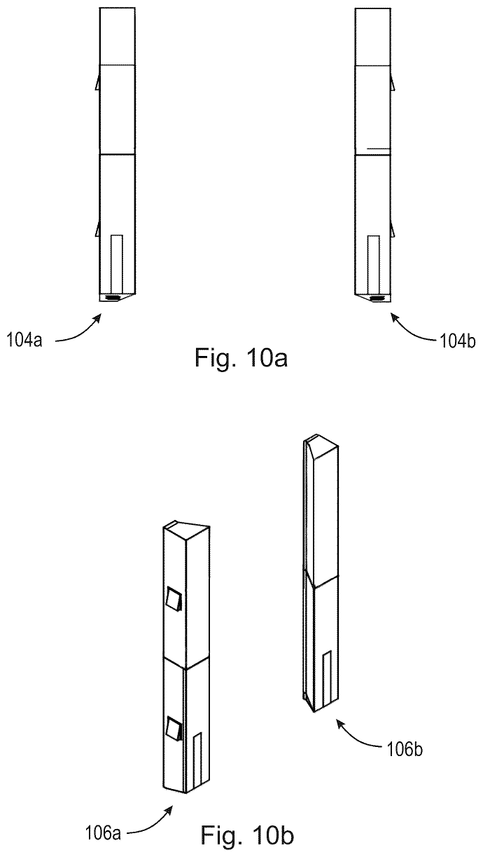

In the example of FIG. 9C, the external wall EW includes metal siding, requiring the side assemblies 102a, 102b to be mounted from inside of the external wall EW. In this example, lag bolts are driven from the inside of the external wall EW into the back of the side assemblies 102a, 102b with the straight brackets 124, 142 used as washers between the metal siding of the external wall EW and the backs of the side assemblies 102a, 102b. The resulting side assemblies 102a, 102b of FIGS. 9A-9C are shown in FIGS. 10A and 10B.

Once the side assemblies 102a, 102b are installed, the curtain assembly 108 may be installed as shown in the exploded view of FIG. 3. In this example, the curtain 110 and the split backboard 154 are already secured to the frame member 150. The curtain assembly 108 may be installed by first forming the split stiffener pipe 176 by coupling the first stiffener rod 156a to the second stiffener rod 156b using the split rod coupling 158. The split stiffener piper 176 is then slid into a pocket of the curtain 110 to provide structure to the curtain 110. The split backboard 154 is then rested on top of the side assemblies 102a, 102b, allowing the first and second boards 152a, 152b to be fixed to the external wall EW using a plurality of anchors. The tie back straps 160 of the curtain 110 may be attached to the backboards 162 of the side assemblies 102a, 102b to hold the curtain 110 in place. In some examples, caulk may be used to seal the edge between the curtain 110 and the external wall EW.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A modular dock seal for a loading dock to form an environmental enclosure along one or more side walls of a trailer when the trailer is parked in a trailer bay of the loading dock, wherein the loading dock has an exterior wall with a door opening, and wherein the modular dock seal comprises:
a pair of side pad assemblies configured to be secured to the exterior wall of the loading dock alongside the door opening, wherein each side pad assembly comprises:
an upper compression pad comprising a top face and a bottom face; and
a lower compression pad comprising a top face and a bottom face, wherein the top face of the lower compression pad is arranged to meet the bottom face of the upper compression pad.

2. The modular dock seal of claim 1, wherein the upper compression pad and the lower compression pad each have a length of less than or equal to 72 inches.

3. The modular dock seal of claim 1, wherein the upper compression pad and the lower compression pad each have a weight of less than or equal to 60 pounds.

4. The modular dock seal of claim 1, further comprising a curtain assembly configured to be secured to the exterior wall above the upper compression pad of each of the pair of side pad assemblies.

5. The modular dock seal of claim 4, wherein the curtain assembly comprises:
a split backboard comprising a first board and a second board, wherein the first board and the second board are both secured to the exterior wall;
a frame member secured to the split backboard;
a curtain affixed to and arranged to hang down from the frame member; and
a split stiffener pipe attached to or arranged within the curtain, wherein the split stiffener pipe comprises a first stiffener rod, a second stiffener rod, and a split rod coupling configured to connect the first stiffener rod to the second stiffener rod.

6. The modular dock seal of claim 1, wherein the upper compression pad and/or the lower compression pad are substantially wedge-shaped.

7. The modular dock seal of claim 1, wherein the upper compression pad and the lower compression pad each comprise:
a foam body;
a base layer surrounding the foam body; and
a wear face partially covering the base layer.

8. A method for assembling a modular dock seal, comprising:
coupling one or more brackets to each of a plurality of compression pads, wherein the plurality of compression pads comprises an upper left compression pad, a lower left compression pad, an upper right compression pad, and a lower right compression pad;
fastening, via a first portion of the one or more brackets, the upper left compression pad and the lower left compression pad along a left-side of a door opening in an exterior wall, wherein a top face of the lower left compression pad is arranged to meet a bottom face of the upper left compression pad; and
fastening, via a second portion of the one or more brackets, the upper right compression pad and the lower right compression pad along a right-side of the door opening in the exterior wall, wherein a top face of the lower right compression pad is arranged to meet a bottom face of the upper right compression pad.

9. The method of claim 8, wherein the one or more brackets are coupled to an outer face of each of the plurality of compression pads.

10. The method of claim 9, wherein the one or more brackets are angled brackets.

11. The method of claim 8, wherein the one or more brackets are coupled to a straight inner face of each of the plurality of compression pads.

12. The method of claim 11, wherein the one or more brackets are straight brackets.

13. The method of claim 8, further comprising securing a curtain assembly to the exterior wall.

14. The method of claim 13, wherein securing the curtain assembly comprises:
securing a split backboard above the door opening in the exterior wall, wherein the split backboard includes a first backboard and a second backboard;
securing a frame member to the split backboard;
affixing a curtain to the frame member, wherein the curtain is arranged to hang down from the frame member;
connecting, via a split rod coupling, a first stiffener rod to a second stiffener rod to form a stiffener rod; and
arranging the stiffener rod within the curtain or attaching the stiffener rod to the curtain.
